(19) United States
(12) Patent Application Publication
(10) Pub. No.: US 2004/0129896 A1
(43) Pub. Date: Jul. 8, 2004

(54) Method and device for generating extreme ultravilolet radiation in particular for lithography

(76) Inventors: Martin Schmidt, Vanves (FR); Olivier Sublemontier, Fontenay-Aux-Roses (FR); Tiberio Ceccotti, Paris (FR); Marc Segers, Les Ulis (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/473,597

(22) PCT Filed: Apr. 16, 2002
(86) PCT No.: PCT/FR02/01306

(30) Foreign Application Priority Data
Apr. 18, 2001 (FR) 01/05241

(51) Int. Cl. H05G 2/00

(52) U.S. Cl. 250/492.2; 250/504 R

(57) ABSTRACT

Method and device for generating light in the extreme ultraviolet, notably for lithography.

According to the invention, a laser beam (24) is caused to interact with a dense fog (20) of microdroplets of a liquid. This liquid is a liquefied noble gas. In particular, liquid xenon (6) is used, the latter is produced by liquefying gaseous xenon (10) with which liquid xenon is pressurized to a pressure from 5×10⁵ Pa to 50×10⁵ Pa, and this liquid xenon is maintained at a temperature from −70° C. to −20° C., the pressurized liquid xenon is injected into a nozzle (4) the minimum internal diameter of which ranges from 60 μm to 600 μm, this nozzle opening into an area where pressure is equal to or less than 10⁻¹ Pa.

### TECHNICAL FIELD

The present invention relates to a method and a device for generating light in the extreme ultraviolet region, notably for lithography by means of such a light.

The increase in the power of integrated circuits and the integration of more and more functions into a small space require a great technological jump in the lithographic technique, used traditionally for manufacturing integrated circuits.

The microelectronics industry notably provides the use of radiation from the extreme ultraviolet (EUV) region for insolating photosensitive resins in order to achieve critical dimensions less than or equal to 50 nanometers on silicon.

In order to produce this radiation, for which the wavelength lies between 10 nm and 15 nm, a large number of techniques have already been suggested. In particular, irradiation of a target, by focussed laser radiation seems to be the most promising technique for achieving good performances in the mean term both in terms of average power, space and time stability and reliability.

The optimization of these performances is achieved by using a dense and directive jet of a fog of micrometric droplets, as a target. In addition, by using this target very little debris are produced, and the jet's directivity provides considerable reduction in the amount of debris indirectly produced by the erosion of the nozzle emitting the jet, an erosion which is caused by the plasma formed by the impact of the laser radiation on the target.

### STATE OF THE PRIOR ART

Different techniques for producing EUV radiation are known, for example that consisting of irradiating a target placed in vacuo by a laser beam.

In particular, in the field of lithography for integrated circuits, a target must be found which is capable of being irradiated by a laser in order to produce light in the extreme ultraviolet and which is compatible with industrial utilization of lithography.

The generation of EUV radiation, by irradiating a dense jet of xenon on which is focussed a beam emitted by a nanosecond laser, is known from the following documents:

[1] Paul D. Rockett et al., “A high-power laser-produced plasma UVL source for ETS”, 2^{nd} International Workshop on EUV Lithography (San Francisco, October 2000)

[2] Kubiak and Richardson, “Cluster beam targets for laser plasma extreme ultraviolet and soft x-ray sources”, U.S. Pat. No. 5,577,092 A.

Reference will also be made to the following document:

[3] Haas et al., “Energy Emission System for Photolithography”, WO 99 51357 A.

In this document [3], the use of a jet of xenon clusters as a target is not mentioned specifically but it is clearly assumed that the formation of the target is obtained by clustering of gas atoms.

As a reminder, xenon clusters are grains with an average size much smaller than 1 μm, which are obtained by clustering of xenon gas during an adiabatic expansion of the latter through a nozzle, in a vacuum enclosure.

Irradiation of these clusters by a laser beam in the near infrared produces a plasma which emits a more energetic radiation with a wavelength located in the extreme ultraviolet. The coupling between the laser and the target and therefore the efficiency of this conversion process may be significant in the case of irradiation of a jet of xenon clusters in the wavelength band of interest.

A significant portion of the laser light is thus absorbed, which favors the generation of a plasma by the heating of the clusters.

Further, the local density of the atoms in each cluster is relatively high, so that a large number of atoms are involved. In addition, the large number of clusters including a sufficiently high average number of atoms and being in the focussing area of the laser beam, makes the emission in the extreme ultraviolet, relatively intense.

On the other hand, significant material debris may result from the erosion of the nozzle when the latter is placed too close to the area illuminated by the laser.

In addition, the closeness of the illuminated area and of the nozzle may cause heating of the latter with deterioration of the jet's characteristics.

By using a jet, which forms a renewable target, it is possible to operate at a high rate (of the order of 10 kHz and beyond), which is perfectly adapted to lithographic units for manufacturing integrated circuits with a very high degree of integration.

The use of xenon as a clustering gas gives the best results as regards the emission of extreme ultraviolet radiation as this gas has a large number of emission lines in the considered spectral band, notably between 13 nm and 14 nm.

However, the EUV radiation source, which is known from documents [1] and [2], has a certain number of drawbacks which are mentioned hereafter.

According to these documents [1] and [2], the density of the clusters strongly decreases upon moving away from the nozzle which the source includes, which is the sign of a too large divergence of the cluster jet. This is why excitation from the laser beam should take place in the direct vicinity of the nozzle, which causes significant erosion of this nozzle by the impact of ions from the generated plasma or by an electric discharge. The nozzle's erosion significantly reduces its lifetime, and therefore the reliability of the EUV radiation source, and generates large amounts of debris, capable of untimely deteriorating the optics of a lithographic apparatus using such a source.

Poor directivity of the xenon cluster jet induces a EUV radiation re-absorption phenomenon by the cluster jet itself, the interaction with the laser taking place at the center of the cluster jet, which substantially reduces the intensity of the actually usable EUV radiation.

The average size of the clusters, thereby formed by condensation from xenon gas, can only be at the most of the order of a few hundred nanometers and in any case remains much less than 1 μm because of the formation method used. Now, the interaction with a pulsed laser of the YAG type, which is typically used for such an application and for which the duration of a pulse lies between 3 ns and 80 ns, is optimal in terms of the produced EUV radiation intensity, with grains of matter having an average size larger than 1 μm and typically lying in the range from 5 μm to 50 μm.

Reference will also be made to the following document:

[4] Richardson et al., “Water laser plasma x-ray point sources”, U.S. Pat. No. 5,577,091 A.

This document [4] discloses a source of EUV radiation, which uses, as a target, a jet of ice microcrystals. This is a succession of microcrystals with a very high repetition rate where each microcrystal typically has an average diameter larger than 50 μm.

Such microcrystals are too large for the penetration of the excitation laser beam to be complete. By reducing the diameter of each microcrystal, the interaction with the laser may be enhanced, but then the number of EUV photon emitters in the plasma is reduced. The technique described in document [4] therefore does not meet the criteria for obtaining a sufficiently intense EUV radiation source.

In addition reference will be made to the following document:

[5] Hertz et al., “Method and apparatus for generating X-ray or EUV radiation” WO 97 40650 A.

Another source of EUV radiation based on the irradiation of a continuous microjet of liquid xenon is known from this document [5]. This kind of target also has the drawback of containing a far too small amount of material in order to obtain a sufficient number of potential EUV emitters. This is due to the relatively small diameter (about 10 μm) of the liquid xenon jet.

Furthermore, the sources known from documents [4] and [5] are not very stable as regards intensity. In the case of document [4], it is difficult to irradiate each ice microcrystal in the same way because of a synchronization problem with the laser. In the case of document [5], the changes in EUV intensity are due to instabilities of the continuous xenon jet.

### DISCUSSION OF THE INVENTION

The present invention relates to a generator of a dense fog of micrometric droplets of a noble gas, in particular xenon, and more particularly to the use of this fog for producing light in the extreme ultraviolet (10 nm-15 nm), by laser irradiation of this dense fog.

The invention is based on the production of a dense and directive jet of a fog of micrometric droplets in vacuo, from a liquefied noble gas, in particular liquid xenon.

The inventors have found that the use of this liquefied noble gas, in particular liquid xenon, gives the best performances in terms of intensity of the produced EUV radiation, in a wavelength range from 13 nm to 14 nm, perfectly matching the characteristics of reflective optics used in industrial photorepeaters.

The dense xenon fog jet propagates in vacuo at a velocity of the order of several tens of m/s. The target is therefore renewed sufficiently rapidly so as to allow this target to be irradiated by a pulsed laser with a high repetition rate (larger than or equal to 10 kHz). A laser of this type is required for obtaining the average power required for the industrial production of integrated circuits by means of an industrial photorepeater.

Under “vacuum”, we understand a pressure which is sufficiently low, so as not to hinder the propagation of this jet, and which may be of the order of a few Pa. However, in order to prevent re-absorption of the light, a much higher vacuum will be required as it will be seen later on, than the one which is necessary here.

In the invention, cryogenic means are used in order to produce the liquefied noble gas, in particular liquid xenon.

The xenon is sent as a gas to a tank next to an output nozzle. The xenon gas injected into the tank is locally liquefied therein by the cryogenic means. The spraying of liquid xenon at the outlet of the nozzle causes the formation of a dense and directive jet of xenon droplets. The jet may be continuous or pulsed by electromechanical or piezoelectric means. The pressure of the injected gas and the temperature of the liquid contained in the tank may be controlled.

Irradiation of the jet thereby formed by a focussed laser generates the creation of a plasma which may have a EUV radiation emission peak between 13 and 14 nm, whereby this radiation may then be used as a light source for lithography.

The present invention provides a technique for generating EUV radiation which does not have the drawbacks mentioned earlier.

More generally, the present invention relates to a method and a device for generating a dense fog of droplets from a liquid, whereby this method and this device may be used for producing EUV radiation and also have high reliability as well as great simplicity which is essential for industrial use.

Specifically, the object of the present invention is a method for generating light in the extreme ultraviolet by generating a plasma from the interaction between a laser beam and a target, this method being characterized in that:

the target consists of a dense fog comprising microdroplets of liquid, this liquid being a liquefied noble gas, in particular liquid xenon, this liquid is produced by liquefying the noble gas, the liquid is pressurized by this noble gas, to a pressure in the range of 5×10⁵ Pa to 50×10⁵ Pa in the case of xenon, while maintaining this liquid xenon at a temperature in the range from −70° C. to −20° C., the pressure and the temperature of the gas further being selected so that the noble gas is in the liquid form, the thereby pressurized liquid is injected into a nozzle, the minimum internal diameter of which lies in the range from 60 μm to 600 μm, this nozzle opening into an area where the pressure is equal to or less than 10⁻¹ Pa, and thus a dense and directive fog of liquefied noble gas droplets is generated in the area at the output of the nozzle, with their average size being larger than 1 μm, in particular lying in the range from 5 μm to 50 μm in the case of xenon, this dense fog forming a jet which is directed along the axis of the nozzle, and

a laser beam is further focussed on the thereby obtained dense fog, this laser beam being able to interact with this dense fog in order to generate light in the extreme ultraviolet region.

According to a preferred embodiment of the method, object of the invention, the noble gas is xenon, and liquid xenon is pressurized by xenon gas to a pressure lying in the range from 15×10⁵ Pa to 25×10⁵ Pa and this liquid xenon is maintained at a temperature lying in the range from −45° C. to −30° C.

When the noble gas is preferably xenon, the light generated in the extreme ultraviolet region may be used for insolating a substrate on which is deposited a layer of photosensitive resin.

The object of the present invention is also a device for generating light in the extreme ultraviolet by generating a plasma from the interaction between a laser beam and a dense fog consisting of microdroplets of a liquid, this device being characterized in that the liquid is a liquefied noble gas, in particular liquid xenon, and in that the device comprises:

a tank for containing the liquid,

means for injecting the noble gas under pressure into the tank, provided for pressurizing with this noble gas, the liquid contained in the tank to a pressure lying in a range from 5×10⁵ Pa to 50×10⁵ Pa in the case of xenon,

means for producing the liquid contained in the tank, by liquefying the noble gas which is injected into the tank, the liquid, when the noble gas is xenon, being maintained at a temperature lying in the range from −70° C. to −20° C.,

a nozzle, the minimum internal diameter of which lies in the range from 60 μm to 600 μm and which is connected to the tank,

a vacuum chamber containing the nozzle,

means for allowing a laser beam capable of interacting with the fog, to penetrate into the vacuum chamber,

means for recovering the produced light, in order to use this light, and

first pumping means provided for establishing in this vacuum chamber, a first pressure approximately equal to or less than 10⁻¹Pa, the injection means and the liquid production means being placed under operating conditions which maintain the liquid noble gas in the nozzle and allow, in the vacuum chamber, at the outlet of the nozzle, a dense and directive fog of liquefied noble gas droplets to be generated, the average size of which is larger than 1 μm, in particular lying in the range from 5 μm to 50 μm in the case of xenon, this dense fog forming a jet which is directed along the axis of the nozzle.

According to a preferred embodiment of the device, object of the invention, the noble gas is xenon and the pressure which liquid xenon contained in the tank is subjected to, lies in the range from 15×10⁵ Pa to 25×10⁵ Pa and the temperature at which the liquid xenon is maintained, lies in the range from −45° C. to −30° C.

The device object of the invention may further comprise:

a wall which delimits a secondary area and which is provided with a bore facing the nozzle, this bore being on the axis of the nozzle, and

second pumping means provided for establishing in this secondary area a second pressure larger than the first pressure.

Preferably, the wall includes a skimmer, the axis of which coincides with the axis of the nozzle and the aperture of which forms the bore of the wall.

The device, object of the invention, may additionally comprise a heat shield which is perforated and faces the nozzle in order to provide passage for the jet formed by the dense fog.

Preferably, resistivity of the constituent material of the nozzle is larger than or equal to 10⁸ Ω.cm, heat conductivity of this material is larger than or equal to 40 W/mK and the Vickers hardness number of the material is larger than or equal to 8,000 N/mm².

This material is a ceramic, for example.

This ceramic is preferably aluminum nitride.

The device, object of the invention may further comprise a collector capable of directing or focussing the generated light towards means for using this light.

This collector may include at least a concave reflector.

According to a particular embodiment of the device, object of the invention, this device additionally comprises means for protecting the optics which may be contained in the device with regard to possible debris.

According to various particular embodiments, these protection means are:

means for causing the noble gas of the vacuum chamber to circulate in front of the surface of these optics, which is exposed to these debris,

or means for heating the surface of these optics, which is exposed to these debris,

or means for positively biasing a metal layer which is included in these optics.

The present invention further relates to a lithographic apparatus for semiconducting substrates, this apparatus comprises:

means for supporting a semiconducting substrate on which is deposited a layer of photosensitive resin which is intended to be insolated according to a determined pattern,

a mask comprising the determined pattern in an enlarged form,

a device for generating light in the extreme ultraviolet region, in accordance with the invention,

optical means for transmitting the light to the mask, the latter providing an image of the pattern in an enlarged form, and

optical means for reducing this image and projecting the reduced image onto the photosensitive resin layer.

### SHORT DESCRIPTION OF THE DRAWINGS

The present invention will be better understood upon reading the description of exemplary embodiments given as purely indicative and non-limiting, hereafter, with reference to the appended drawings wherein:

FIG. 1 is a schematic view of a particular embodiment of the device, object of the invention, for generating a dense fog of xenon droplets,

FIGS. 2 and 3 are schematic views of examples of nozzles which may be used in the device of FIG. 1,

FIG. 4 is a portion of the xenon phase diagram, showing above the saturation vapor pressure curve, the operating domain of the device of FIG. 1 (hatched) and the optimum operating domain of this device (cross-hatched),

FIG. 5 is an experimental curve illustrating the change in the relative intensity of the produced EUV radiation versus the temperature of the nozzle and of the tank of the device of FIG. 1, and

FIG. 6 is a schematic view of a lithographic apparatus according to the invention.

### DETAILED DISCUSSION OF PARTICULAR EMBODIMENTS

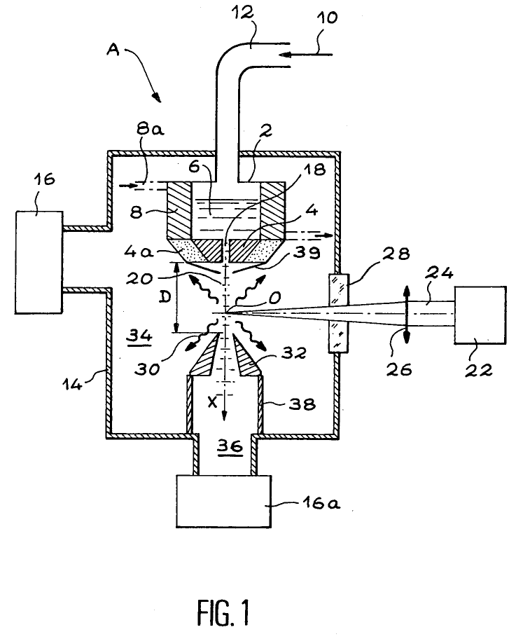

The device A for generating a fog according to the invention, which is schematically illustrated in FIG. 1, comprises a tank 2 and a nozzle 4. This nozzle 4 is positioned close to the tank 2 and communicates with the latter.

This tank 2 is for containing liquid xenon 6. Cryogenic means 8 are provided for producing this liquid xenon 6 from xenon gas 10.

Furthermore, the liquid xenon 6 is pressurized by this xenon gas 10. The latter is injected into the tank 2 via a duct 12 and liquefied by the cryogenic means 8 in order to form liquid xenon.

As an example, these cryogenic means comprise a tube 8a which clasps the tank and the nozzle, only portions of this tube are illustrated in dot and dash lines in FIG. 1, and a cryogenic fluid, for example nitrogen, runs through this tube.

In addition, these cryogenic means 8 comprise control means (not shown) capable of maintaining liquid xenon at a set temperature T, with −70° C.≦T≦−20° C. and preferably −45° C.≦T≦−30° C.

The temperature conditions of the nozzle 4 and the tank 2, and the pressure conditions of the xenon gas 10 injected into the tank 2, are the essential parameters which determine the size of the liquid xenon droplets exiting from the nozzle 4.

This nozzle 4 opens into a vacuum chamber 14 which is provided with pumping means 16 for establishing therein a pressure much less than the pressure of the xenon gas 10.

The liquid xenon 6, which arrives in the nozzle 4, is thus violently expelled through the hole 18 of the latter into the vacuum chamber 14 and forms a dense fog 20 therein, formed by the liquid xenon droplets.

The dense fog 20 forms a jet which is strongly confined onto the axis X of the nozzle which is also the axis of the hole 18 of this nozzle.

The application of a dense fog 20 of liquid xenon droplets is now considered for generating EUV radiation.

In order to excite this fog, a pulsed laser 22 of the YAG type for example, is used, for which the pulse energy preferably lies between 0.2 J and 2 J, and the pulse duration preferably lies between 3 ns and 80 ns. In addition, focussing means should allow the laser beam to attain sufficient illumination on the targets for igniting the plasma, i.e. for xenon, an illumination equal to or larger than 5×10¹¹ W/cm².

The beam 24 provided by the laser 22 is focussed on the fog 20 by means of a lens 26 or a mirror.

It is specified that in the illustrated example, the laser beam 24 is fed into the vacuum chamber 14 through a porthole 28 transparent to this laser beam and mounted on a wall of the vacuum chamber.

In FIG. 1, the EUV radiation emitted by the droplets of liquid xenon is symbolized by the arrows 30 orientated in all directions. However, the greatest amount of EUV light is produced by the half-sphere of plasma facing the laser beam, this plasma resulting from the interaction between the dense fog and the laser beam.

One or more portholes (not shown) are provided on one or more walls of the chamber 14 in order to recover the EUV radiation in order to use it. However, one would not depart from the scope of the invention by integrating the source within an apparatus intended for the use of the produced radiation, notably if this apparatus operates in the same gas environment as the source and the porthole may thus be spared. In this case, the function of enclosure 14 is fulfilled by the enclosure of the entire apparatus.

In order that the interaction between the dense fog 20 and the focussed laser beam 24 produces an optimized EUV radiation 30, the average size of the droplets is adjusted by acting on the pressure of the injected xenon gas and on the temperature of the nozzle 4 and of the tank 2.

Preferentially, when the noble gas is xenon, the pressure of the injected xenon gas may lie between 15 bars (15×10⁵ Pa) and 25 bars (25×10⁵ Pa) and the temperature of the nozzle and of the tank lies between −45° C. and −30° C. so that the average size of the droplets is between 5 μm and 50 μm.

The control of the temperature of the nozzle and of the tank may be achieved by using together liquid nitrogen and any heat generating means for maintaining a given temperature. It may also be achieved by using one or more Peltier modules or by using a conventional cooling system, or even a system operating as a heat pump.

For optimum operation of the EUV radiation source produced by interaction of the focussed laser beam 24 with the fog 20, the material of the nozzle 4, through which liquid xenon flows from tank 2 to the vacuum chamber 14 by being sprayed as droplets, should have the physical properties mentioned hereafter.

1) This material should be electrically insulating, in order to prevent any possible electrical discharge phenomena between the nozzle 4 and the plasma, formed by the interaction between the laser beam and the target (dense fog). The electrical resistivity of this material should be larger than 10⁸ Ω.cm and preferentially may be of the order of 10¹⁴ Ω.cm.

2) This material should be a good heat conductor, in order to keep xenon in the liquid state between the inlet and outlet of nozzle 4. The heat conductivity of this material should be larger than 40 W/mK. Preferentially, it should be of the order of 180 W/mK.

3) This material should be sufficiently hard, in order to withstand the flowing of liquid xenon through the nozzle 4 and the abrasion possibly caused by the plasma which results from the interaction between the laser beam and the target formed by the dense fog. Its Vickers hardness number should be larger than 8,000 N/mm² and preferentially may be of the order of 12,000 N/mm².

The material preferentially used for the nozzle is a ceramic, preferably aluminum nitride (AlN).

However, other ceramics may be used, alumina or silicon nitride for example.

A diaphragm, i.e. a single membrane provided with a calibrated aperture, or a skimmer 32 may be provided in the vacuum chamber 14 and placed facing the nozzle 4 in order to facilitate the pumping of the vacuum chamber 14, by separating the latter into two distinct portions 34 and 36, the skimmer differing from the diaphragm in that with its pointed shape, it may less intercept EUV radiation, which makes it more advantageous.

For this, as it is seen in FIG. 1, a wall 38 is provided for delimiting portion 36 with respect to the other portion 34 and the skimmer 32 extends this wall 38.

The axis of this skimmer 32 coincides with the axis X of nozzle 4. Further, this skimmer is placed at a distance D from nozzle 4, which lies between the vicinity of the illuminated area and a distance to the nozzle of 10 mm, and the internal diameter of this skimmer lies between 1 mm and 4 mm.

The portion 34 of the vacuum chamber 14, portion which contains the nozzle 4 as well as the plasma formed by interaction between the laser beam and the jet of droplets, its pumped by pumping means 16, until a pressure lower than or equal to 10⁻¹ Pa is obtained in this portion 34. This value of 10⁻¹ Pa is a maximum admissible value in order to avoid a phenomenon of too large reabsorption of EUV radiation by the xenon gas present in this portion 34, or upper portion, of the vacuum chamber 14.

The portion of the fog which has not been subjected to the interaction with the laser beam crosses the skimmer 32 so as to be pumped into the portion 36, or lower portion, of the vacuum chamber 14. In this lower portion 36 of the vacuum chamber 14, the pressure may attain about 10 Pa without deteriorating the operation of the EUV radiation source.

It is preferable that the pumping of both portions 34 and 36 of the chamber 14 does not generate any hydrocarbon, in order not to chemically pollute the optics (not shown) for collecting the EUV radiation.

The pumping means 16 of the upper portion 34 of the vacuum chamber 14 may for example, consist of one or more pumps of the turbomolecular type with magnetic bearings, associated with dry primary pumps.

The pumping means 16a of the lower portion 36 of the vacuum chamber 14 may consist of one or more dry primary pumps.

Preferably, the material of the skimmer has the physical properties mentioned earlier in connection with the nozzle 4, in order to prevent erosion of this skimmer.

The material preferentially used for this skimmer is aluminum nitride (AlN) or other ceramics such as alumina or silicon nitride.

It is specified that the skimmer 32 may be replaced with a single diaphragm formed by a planar plate closing the wall 38 and provided with a bore located on axis X, facing the hole 18 of the nozzle 4, this plate being made out from the same material as the skimmer.

A heat shield 39 may be provided between the nozzle 4 and the point 0 of interaction of the beam 24 with the target 20, in order to reduce the heating of the nozzle, which may be induced by the plasma resulting from this interaction.

Preferably, this heat shield 39 is formed by a material having the same physical characteristics as the material of the nozzle (for example AlN), and is fixed on a portion 4a of the fog generating means, this portion being cooled by cryogenic means 8. This portion surrounds the nozzle 4 in the example illustrated.

The heat shield is thus cooled by cryogenic means 8. More generally, this heat shield is preferably provided with cooling means which may be the means used for liquefying the xenon gas but which may also be different from the latter.

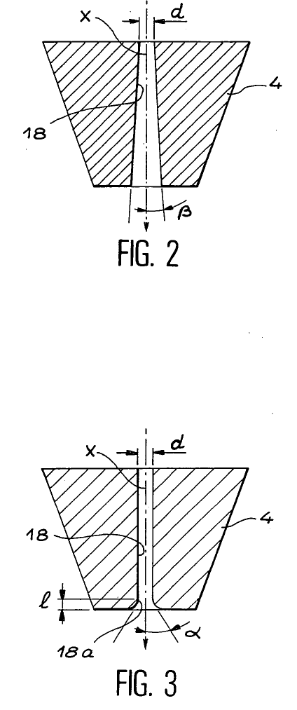

The geometry of the nozzle is one of the parameters which influence the directivity of the jet 20. FIGS. 2 and 3 illustrate two examples of this nozzle geometry, respectively.

Under the pressure conditions of the injected xenon gas 10 (between 5×10⁵ Pa and 50×10⁵ Pa) and the temperature conditions of the nozzle and the tank (between −70° C. and −20° C.), the minimum diameter d of the nozzle or more specifically the minimum diameter of the hole 18 of the latter, lies between 60 μm and 600 μm.

Under these same conditions, the hole 18 of the nozzle 4 may globally have the shape of a cone throughout the length of the nozzle, as shown in FIG. 2. The diameter of this cone increases in the direction of propagation of the jet 20. The apical half-angle β of this cone may lie between 1 degree and 10 degrees.

Alternatively, the hole 18 of the nozzle 4 has a axisymmetrical cylindrical shape around axis X.

Whatever the (cylindrical or conical) shape of the nozzle's hole, the end 18a of this hole which opens into the vacuum chamber may have a flared shape, over a length l lying between 0,2 mm and 2 mm, leading to a local increase of the nozzle's diameter, as shown in FIG. 3. This flared shape may follow (in a longitudinal cut along axis X) a circular, parabolic, hyperbolic, exponential or logarithmic curve.

By selecting the geometry of the nozzle 4 wisely, the directivity of the jet may be optimized on the axis X of propagation of this jet.

For example, a nozzle with an internal cylindrical shape, with an average diameter of 150 μm and including a circular flare at its end 18a, over a length l of 1 mm, is able to provide a fog of droplets having a divergence half-angle α of about 3 degrees, for a temperature of the nozzle of about −35° C. and a pressure of the injected xenon gas of about 20×10⁵ Pa.

This divergence half-angle is very small as compared with that of a conventional cluster jet (of the order of 20 degrees—cf. documents [1] and [2]) and with this angle, a sufficiently large distance may be kept between the outlet of the nozzle and the impact point of the laser beam on the fog, without reducing the intensity of the produced EUV radiation.

If this distance is not sufficiently large, as in the case of a conventional cluster jet (documents [1] and [2]) wherein it is less than or equal to 1 mm, intense heating of the outlet of the nozzle is produced by the plasma induced by the interaction between the laser and the jet and it causes deterioration of the jet and erosion of the nozzle, erosion which induces debris.

The jet of the dense fog of liquid xenon droplets may be sufficiently directive in order to be able to maintain a distance lying between 1 mm and 5 mm, between the outlet of the nozzle and the impact point of the laser beam on this jet, whereby a more intense EUV radiation source, practically free of any material debris, may be obtained.

Preferentially, the EUV light source according to the invention also includes a collector of EUV light. Such a collector consists of reflective optics such as for example one or more concave mirrors placed around the source, so as to receive as much EUV radiation as possible and to direct or focus it towards means using this light. Such a collector, well-known to one skilled in the art, will not be described further. For that matter, it is not illustrated in the drawings as its position depends on the position of the means using this light and these means, also well-known to one skilled in the art, have not been illustrated in FIG. 1.

Finally, the invention also, preferentially, includes means for protecting the optics of the device (for example portholes, focussing devices) from possible debris stemming from the source, even if the source according to the invention generates very little of them. These means may be means for generating a slight blowing, in front of the surface exposed to the EUV radiation, of the ambient gas of the enclosure, even if it is under very low pressure. They may also consist of means capable of generating slight heating of these optics. Finally, they may also consist of means for generating a positive bias of the metal layer which is generally included in these optics, at a sufficient voltage for moving the ion debris away, for example a few hundred volts or more.

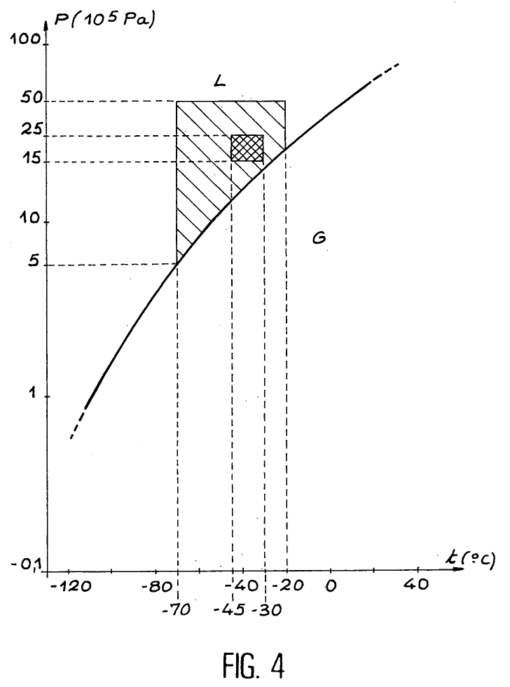

FIG. 4 is a portion of the xenon phase diagram, showing the operating domain of the invention (hatched) for which pressure lies between 5×10⁵ Pa and 50×10⁵ Pa and temperature lies between −70° C. and −20° C., which is further located above the saturation vapor pressure curve. It also shows the optimum operating domain (cross-hatched) corresponding to a pressure between 15×10⁵ Pa and 25×10⁵ Pa and to a temperature between −45° C. and −30° C. The curve of the changes in saturating vapor pressure P is expressed in bars (1 bar being equal to 10⁵ Pa), versus temperature t expressed in ° C.

The portion of the diagram, located on the upper left of this curve corresponds to liquid xenon (L) whereas the portion located on the lower right corresponds to xenon gas (G).

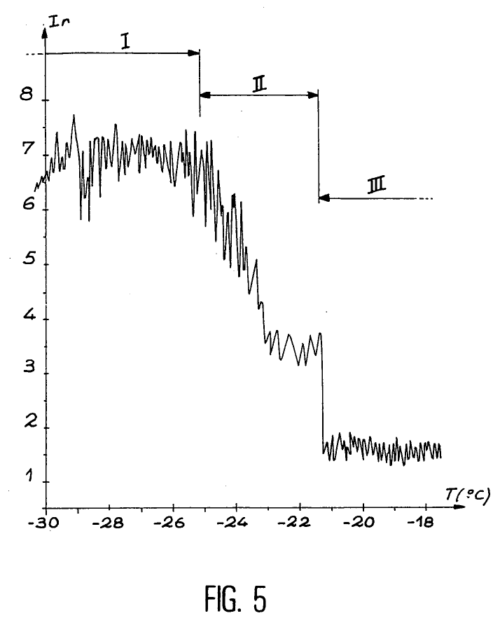

FIG. 5 shows, for an impact point of the laser located at 3 mm from the nozzle and for a pressure of injected xenon gas of about 24×10⁵ Pa, the change in relative intensity Ir of the produced EUV radiation, with a wavelength close to 13.5 nm, versus the measured temperature T (° C.) of the tank and the nozzle.

The difference in intensities of EUV radiation produced by a conventional xenon cluster jet and that produced by a dense fog of liquid xenon droplets may be demonstrated with this FIG. 5.

FIG. 5 is split up into three distinct portions:

Portion I: the measured temperature of the tank 2 and of the nozzle is less than −25° C. In this portion I, the xenon phase diagram clearly shows that xenon is liquid under these temperature and pressure conditions. Tank 2 contains liquid xenon, exclusively. A jet of a dense fog of xenon droplets is therefore present, formed by the spray of liquid xenon present upstream from the nozzle 4. The produced EUV radiation flux is high.

Portion II: the measured temperature of the tank and of the nozzle lies between −25° C. and about −21.3° C. In this portion II, the xenon phase diagram shows that xenon passes from the liquid state to the gaseous state. Tank 2 contains both liquid xenon and xenon gas. This is a liquid-vapor phase transition. The produced EUV radiation flux is lowered.

Portion III: the measured temperature of the tank and the nozzle is larger than −21.3° C. In this portion III, the xenon phase diagram clearly shows that xenon is a gas under these temperature and pressure conditions. Tank 2 contains xenon gas, exclusively. Under these temperature and pressure conditions, and with a nozzle of a diameter of 500 μm, a conventional xenon cluster jet is formed, by condensation of xenon gas present upstream from the nozzle. The produced EUV radiation flux is low. It is about five times lower than with a dense fog of xenon droplets.

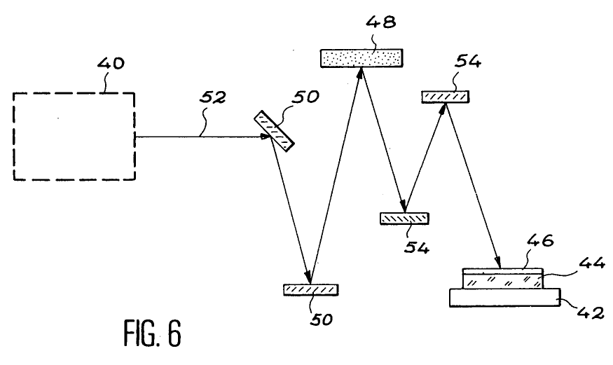

FIG. 6 very schematically illustrates the use of the EUV radiation obtained with a device according to the invention, for nanolithography.

The nanolithographic apparatus schematically illustrated in this FIG. 6 comprises a EUV radiation generating device 40 of the type of EUV radiation source which has been described with reference to FIG. 1.

Nevertheless, as this apparatus itself also operates under very low pressure, it may have certain components in common with the source, notably pumping means. It may also include components like the EUV light collector, which functionally belongs to the source, but which may be fixed onto the etching apparatus mechanically without departing from the scope of the invention. The optional means for cleaning the optics with regard to debris from the source may also be set up on the nanolithographic apparatus mechanically.

The nanolithographic apparatus of FIG. 6 also comprises a support 42 for the semiconducting substrate 44 which is intended to be processed and which is covered with a layer 46 of photosensitive resin to be insolated according to a determined pattern.

The apparatus also comprises:

a mask 48 comprising this pattern in an enlarged form,

optics 50 provided for shaping EUV radiation referenced as 52 stemming from device 40, and for bringing this radiation 52 to the mask 48 which then provides an image of the pattern in an enlarged form, and

optics 54 provided for reducing this enlarged image and projecting the reduced image onto the photosensitive resin layer 46.

Support 42, mask 48 and optics 50 and 54 are positioned in a vacuum chamber not shown, which, for the sake of simplification, is preferably the vacuum chamber wherein the insolation EUV radiation 52 is formed.

The invention is not only applied to lithography for manufacturing integrated circuits with a very high degree of integration: the EUV radiation produced by means of the present invention has many other applications, notably in materials science and microscopy.

In addition, the invention is not limited to xenon. Other noble gases, such as argon, may be used for forming the dense fog and producing the EUV radiation.

However, for lithography, it is preferable to use xenon.

The invention aims at the production of EUV light. However, it produces a large number of lines ranging from the visible region to soft X rays and may be used for all the produced wavelengths.

1. A method for generating light (30) in the extreme ultraviolet by generating a plasma from interaction between a laser beam (24) and a target, this method being characterized in that:
the target consists of a dense fog (20) consisting of microdroplets of liquid, this liquid being a liquefied noble gas, in particular liquid xenon, this liquid is produced by liquefying the noble gas, the liquid is pressurized by this noble gas, to a pressure lying in the range from 5×10⁵ Pa to 50×10⁵ Pa in the case of xenon, while maintaining this liquid xenon at a temperature lying in a range from −70° C. to −20° C., the pressure and the temperature of the gas being further selected so that the noble gas is in the liquid form, the thereby pressurized liquid is injected into a nozzle (4), the minimum internal diameter of which lies in a range from 60 μm to 600 μm, this nozzle opening into an area where the pressure is equal to or less than 10⁻¹ Pa, and in the area at the outlet of the nozzle, a dense and directive fog of liquefied noble gas droplets is thereby generated, the average size of which is larger than 1 μm, in particular lying in the range from 5 μm to 50 μm in the case of xenon, this dense fog forming a jet which is directed along the axis (X) of the nozzle, and
a laser beam is further focussed onto the thereby obtained dense fog, this laser beam being capable of interacting with this dense fog in order to generate light in the extreme ultraviolet region.

2. The method according to claim 1, wherein the noble gas is xenon and the liquid xenon is pressurized by the xenon gas to a pressure lying in the range from 15×10⁵ Pa to 25×10⁵ Pa and this liquid xenon is maintained at a temperature lying in the range from −45° C. to −30° C.

3. The method according to any of claims 1 and 2, wherein the noble gas is xenon and the light generated in the extreme ultraviolet region is used for insolating a substrate (44) on which is deposited a photosensitive resin layer (46).

4. A device for generating light (30) in the extreme ultraviolet by generating a plasma from interaction between a laser beam (24) and a dense fog (20) consisting of microdroplets of liquid, this device being characterized in that the liquid is a liquefied noble gas, in particular liquid xenon, and in that the device comprises:
a tank (2) for containing the liquid,
means (12) for injecting the noble gas under pressure into the tank, provided for pressurizing, by means of this noble gas, the liquid contained in the tank and for subjecting this liquid to a pressure lying in the range from 5×10⁵ Pa to 50×10⁵ Pa in the case of xenon,
means (8) for producing the liquid contained in the tank, by liquefying the noble gas which is injected into this tank, the liquid being maintained at a temperature lying in the range from −70° C. to −20° C. when the noble gas is xenon,
a nozzle (4), the minimum diameter of which lies in the range from 60 μm to 600 μm and which is connected to the tank,
a vacuum chamber (14) containing the nozzle,
means (28) for having a laser beam capable of interacting with the fog penetrate into the vacuum chamber,
means for recovering the produced light in order to use this light, and
first pumping means (16) provided for establishing in this vacuum chamber, a first pressure about equal to or less than 10⁻¹ Pa, the injection means being placed under operating conditions which maintain the liquid noble gas in the nozzle and allow, in the vacuum chamber, at the outlet of the nozzle, a dense and directive fog of liquefied noble gas droplets to be generated, the average size of which is larger than 1 μm, in particular lying in the range from 5 μm to 50 μm in the case of xenon, this dense fog forming a jet which is directed along the axis (X) of the nozzle.

5. The device according to claim 4, wherein the noble gas is xenon and the pressure to which the liquid xenon contained in the tank (2) is subjected, lies in the range from between 5×10⁵ Pa to 25×10⁵ Pa and the temperature at which the liquid xenon is maintained, lies in the range from −45° C. to −30° C.

6. The device according to any of claims 4 and 5, further comprising:
a wall (38) which delimits a secondary area and which is provided with a bore facing the nozzle, this bore being on the axis (X) of this nozzle, and
second pumping means (16a) provided for establishing in the secondary area, a second pressure larger than the first pressure.

7. The device according to claim 6, wherein the wall includes a skimmer (32), the axis of which coincides with the axis (X) of the nozzle and the aperture of which forms the bore of the wall.

8. The device according to any of claims 5 to 8, further comprising a heat shield (39) which is perforated, facing the nozzle for providing passage of the jet formed by the dense fog.

9. The device according to any of claims 4 to 8, wherein the resistivity of the constituent material of the nozzle (4) is larger than or equal to 10⁸ Ω.cm, the heat conductivity of this material is larger than or equal to 40 W/mK and the Vickers hardness number of the material is larger than or equal to 8,000 N/mm².

10. The device according to claim 9, wherein the material is a ceramic.

11. The device according to claim 10, wherein the ceramic is aluminum nitride.

12. The device according to any of claims 4 to 11, further comprising a collector capable of directing or focusing the generated light, towards means using light.

13. The device according to claim 12, wherein the collector includes a least one concave reflector.

14. The device according to any of claims 4 to 13, further comprising means for protecting the optics which may be contained in the device, with regard to possible debris.

15. The device according to claim 14, wherein the protection means are means for causing the noble gas of the vacuum chamber to circulate in front of the surface of these optics, which is exposed to these debris.

16. The device according to claim 14, wherein these protection means are means for heating the surface of these optics, which is exposed to these debris.

17. The device according to claim 14, wherein the protection means are means for positively biasing a metal layer which is included in these optics.

18. A lithographic apparatus for semiconducting substrates, this apparatus comprising:
means (48) for supporting a semiconducting substrate (44) on which is deposited a photosensitive resin layer (46) which is intended to be insolated according to a determined pattern,
a mask (48) comprising the determined pattern in an enlarged form,
a device for generating light in the extreme ultraviolet region according to any of claims 4 to 17,
optical means (50) for transmitting the light to the mask, the latter providing an image of the pattern in an enlarged form, and
optical means (54) for reducing this image and projecting the reduced image onto the photosensitive resin layer.
